(19) United States
(12) Patent Application Publication
(10) Pub. No.: US 2020/0060795 A1
(43) Pub. Date: Feb. 27, 2020

(54) DENTAL MIXING PALETTE

(71) Applicants: Michalis Papastamos, Ag. Dimitrios (GR); Alexandros Kosmas, Farsala (GR)

(72) Inventors: Michalis Papastamos, Ag. Dimitrios (GR); Alexandros Kosmas, Farsala (GR)

(21) Appl. No.: 16/547,647

(22) Filed: Aug. 22, 2019

Related U.S. Application Data
(60) Provisional application No. 62/722,917, filed on Aug. 26, 2018.

(51) Int. Cl. A61C 19/00

(52) U.S. Cl. CPC A61C 19/005; A61C 5/60

(57) ABSTRACT

A dental mixing palette for ceramic materials such as dental porcelain. The dental mixing palette has a base body, a bearing member mounted on the base body, a rotary platter mounted on the bearing member for undergoing rotational movement relative to the base body, a mixing part disposed on the rotary platter, and a cover configured to selectively, removably covering the mixing part.

### CROSS-REFERENCE TO RELATED APPLICATION

This application claims the benefit U.S. Provisional Application No. 62/722,917, filed Aug. 26, 2018, the contents of which are incorporated herein by reference in their entirety.

### BACKGROUND

### Technical Field

The present disclosure relates to the field of dentistry and, more specifically to a dental mixing palette for mixing and storing ceramic materials, such as dental porcelain, used for dental technical work, such as ceramic fixed restorations.

### Background Information

Conventional devices for mixing dental compositions, such as mixing palettes, suffer from various disadvantages One problem with conventional dental mixing palettes is that, during use, access to the dental composition is rather difficult and inconvenient. This is particularly due to the specific construction of conventional mixing palettes which, during use, is often required to be repeatedly shifted in position and/or dental technicians are required to repeatedly adjust their working positions in order to have easy access to the dental composition.

It is well-established that the proper moisture content of the dental composition must be maintained during its use and storage. Porcelain, which is frequently used for dental restorative work, is a hard, white, translucent and non-porous ceramic material known for its bio-compatibility and corrosion-resistant properties. Dentists and other professionals who use porcelain for the fabrication of dentures or crown, for example, typically purchase it in the form of a powder to be admixed with water or other suitable liquids. During use, the porcelain mixture rapidly commences to dry-up and harden or set after preparation due to water loss through evaporation. When the porcelain mix dries-up, it attains the consistency of dried mud, and one can mix-it up again and reuse it Leaving the porcelain mix to dry up and then re-mixing can leave trapped air in the mixture if the mixing is not thorough, which must be avoided. The problem is that this may result in tiny air bubbles being trapped in the final restoration, which may cause the tooth to look brighter in some areas or spots. The trapped air bubbles also reduce the strength of the resulting dental restorative since trapped air bubbles introduce weak spots in the final restoration and can result in fractures during firing or worse, after the restorations are in the patient's mouth. For this reason, it is important to add water or other suitable liquid to maintain the porcelain mixture in a workable state in order to avoid reduced strength of the resulting dental restorative. The addition of water or other suitable liquid also avoids or reduces unnecessary mixings of the porcelain mixture.

Conventional dental mixing palettes are also difficult to clean and not suitable for replacement of its parts. Some also have a complicated and cumbersome design which makes them difficult to fabricate and use.

In view of the foregoing, there is a need for a dental mixing palette which overcomes the foregoing drawbacks in the conventional art.

### SUMMARY

The present disclosure relates to a dental mixing palette for mixing and storing ceramic materials, such as dental porcelain, used for dental technical work, such as ceramic fixed restorations.

It is an object of the present disclosure to provide a dental mixing palette for ceramic materials, such as dental porcelain, which is capable of maintaining the proper moisture content of the materials both during use and storage.

Another object of the present disclosure to provide a dental mixing palette having a mixing surface configured to be easily rotated in a turntable fashion to facilitate access to working material on the mixing surface during use of the dental mixing palette.

Still another object of the present disclosure is to provide a dental mixing palette having components which are easily separable for cleaning and periodic replacement.

Yet another object of the present disclosure is to provide a dental mixing palette that is designed for ease of fabrication and use.

Other objects and advantages of the present disclosure will be apparent upon reference to the accompanying description when taken in conjunction with the following drawings.

### BRIEF DESCRIPTION OF THE DRAWINGS

The following detailed description of the embodiments of the disclosure will be better understood when read in conjunction with the accompanying drawings. For the purpose of illustrating the disclosure, there is shown in the drawings an embodiment which is presently preferred. It should be understood, however, that the disclosure is not limited to the precise arrangement and instrumentalities shown.

FIG. 1 is a top perspective view of a dental mixing palette according to an embodiment of the present disclosure, in which both lids of the dental mixing palette are shown in a closed state.

FIG. 2 is a bottom perspective view of the dental mixing palette in FIG. 1.

FIG. 3 is a top view of the dental mixing palette in FIG. 1.

FIG. 4 is a front view of the dental mixing palette in FIG. 1.

FIG. 5 is a side view of the dental mixing palette in FIG. 1.

FIG. 6 is a view similar to FIG. 1, but with one of the lids shown in an open state.

FIG. 7 is a top view of the dental mixing palette in FIG. 6.

FIG. 8 is a front view of the dental mixing palette in FIG. 6.

FIG. 9 is a side view of the dental mixing palette in FIG. 6.

FIG. 10 is a view similar to FIG. 1, but with one of the lids removed.

FIG. 11 is a bottom perspective view of the dental mixing palette in FIG. 10.

FIG. 12 is a top view of the dental mixing palette in FIG. 10.

FIG. 13 is a front view of the dental mixing palette in FIG. 10.

FIG. 14 is a side view of the dental mixing palette in FIG. 10.

FIG. 15 is a view similar to FIG. 1, but with both lidss removed.

FIG. 16 is a top view of the dental mixing palette in FIG. 15.

FIG. 17 is a front view of the dental mixing palette in FIG. 15.

FIG. 18 is a side view of the dental mixing palette in FIG. 15.

FIG. 19 is a top perspective exploded view of the dental mixing palette according to the embodiment of the present disclosure.

FIG. 20 is a bottom perspective exploded view of the dental mixing palette according to the embodiment of the present disclosure.

FIG. 21 is a cross-sectional view taken along line 21-21 in FIG. 1.

FIG. 22 is a front exploded view of the dental mixing palette shown in FIG. 21.

FIG. 23 is a cross-sectional exploded view taken along line 23-23 in FIG. 15.

FIG. 24 is a cross-sectional exploded view taken along line 24-24 in FIG. 15.

FIG. 25 is an enlarged, close-up view of a portion of the dental mixing palette of FIG. 1 showing details of a hinge connection for the lids, with a hinge clip shown in a detached state relative to both lids.

FIG. 26 is an enlarged, close-up view similar to FIG. 25, but with the hinge clip shown in an attached state relative to both lids to provide the hinged connection for the lids.

FIG. 27 is a view similar to FIG. 26, but with one of the lids removed and the hinge clip connected to the other lid.

FIG. 28 is a view similar to FIG. 27, but with the hinge clip shown displaced by a rotation angle relative to FIG. 27.

FIG. 29 is a view similar to FIG. 27, but the hinge clip shown displaced by a rotation angle different from FIGS. 26 and 27.

FIG. 30 is a top perspective cross-sectional view of a base body and bearing member of the dental mixing palette of FIG. 1 and illustrating a liquid reservoir of the base body being filled with a liquid.

FIG. 31 is a top perspective cross-sectional view similar to FIG. 30, and additionally showing the rotary platter and mixing part of the dental mixing palette in place, as well as a wick being mounted on a surface of the mixing part and extending into the liquid reservoir in contact with the liquid for transferring the liquid from the liquid reservoir to the surface of the mixing part during use of the dental mixing palette.

### DETAILED DESCRIPTION

The present disclosure now will be described more fully hereinafter with reference to the accompanying drawings, in which an exemplary embodiment of the disclosure is shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

It should also be understood that the terms “about,” “approximately.” “generally,” “substantially” and like terms, used herein when referring to a dimension or characteristic of a component of the present disclosure, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

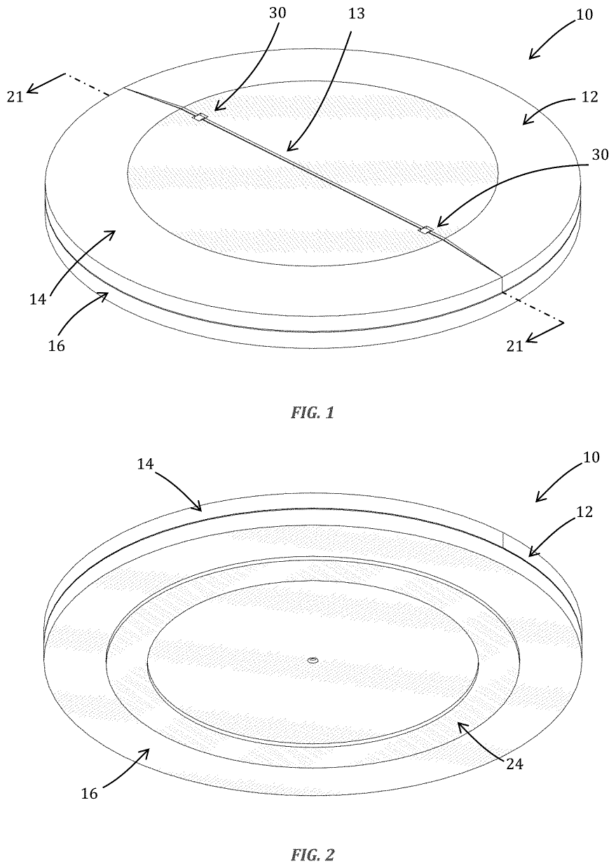

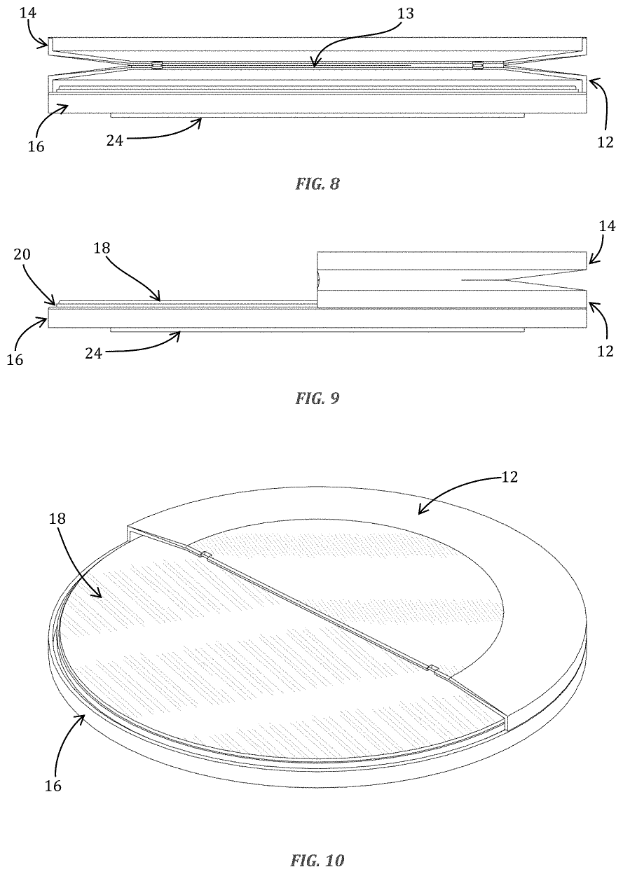

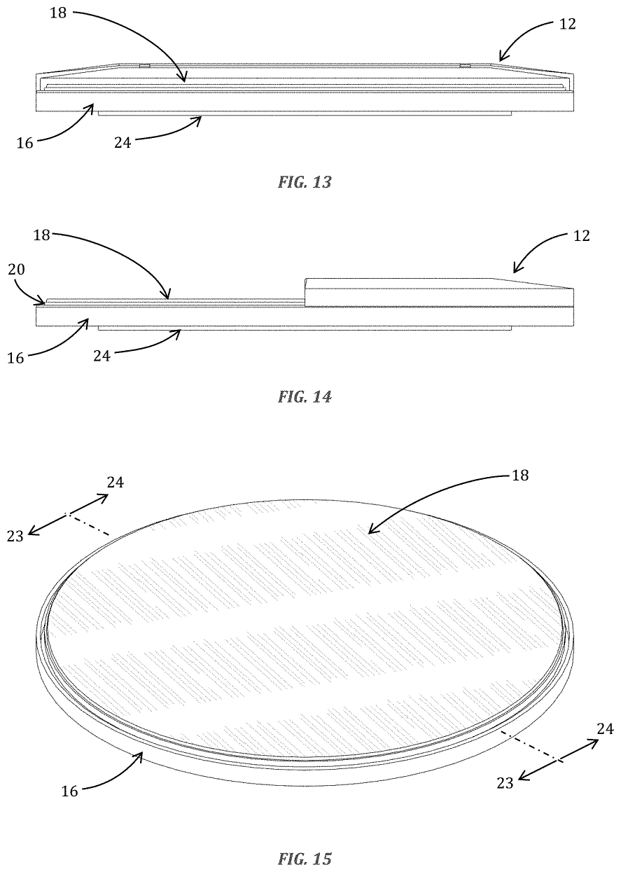

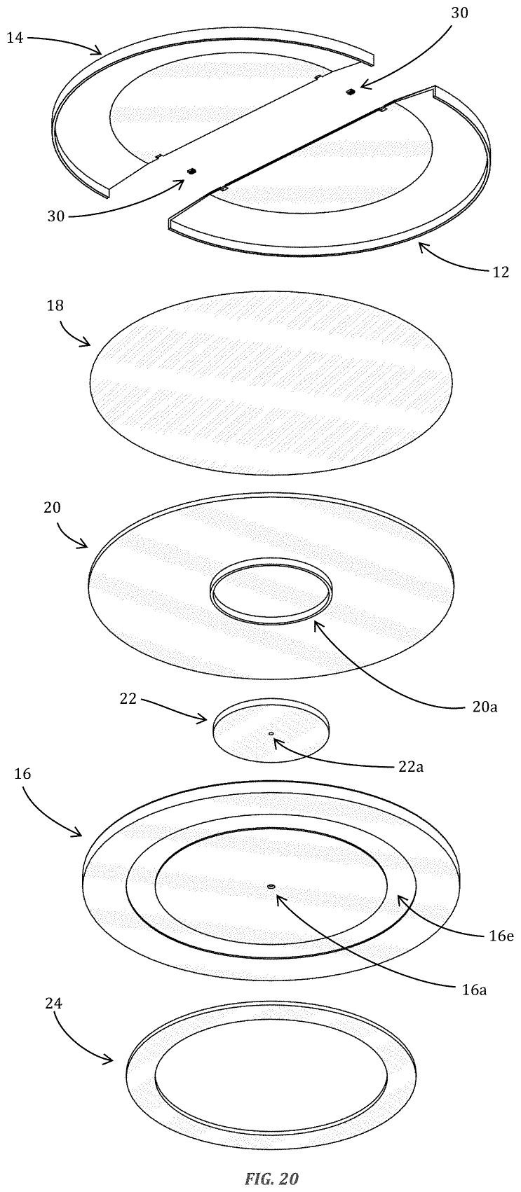

FIGS. 1-31 show an embodiment of a dental mixing palette, generally designated with numeral 10, according to an embodiment of the present disclosure. Dental mixing palette is particularly suitable for mixing and storing ceramic materials (working material), such as dental porcelain, used for dental technical work, such as ceramic teeth modeling and ceramic fixed restorations.

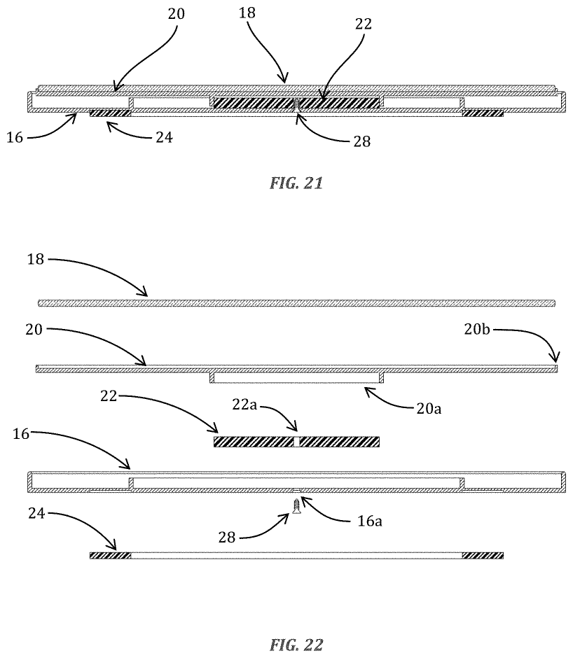

Reference is first made to FIGS. 1-5 and 19-22, where FIG. 1 is a top perspective view of dental mixing palette 10 with both lids 12, 14 shown in a closed state, FIGS. 2-5 are a bottom perspective view, a top view, a front view and a side view, respectively, of dental mixing palette 10 shown in FIG. 1, FIG. 19 is a top perspective exploded view of dental mixing palette 10, FIG. 20 is a bottom perspective exploded view of dental mixing palette 10, FIG. 21 is a cross-sectional view taken along line 21-21 in FIG. 1, and FIG. 22 is a front exploded view of the dental mixing palette shown in FIG. 21. In this embodiment, dental mixing palette 10 has a substantially circular configuration and includes a cover formed of lids 12, 14, a base body 16, a mixing part 18, a rotary platter 20, a bearing member 22, and a foot element 24.

Base body 16 has a substantially circular configuration and is provided with opposite first and second main surfaces and a through hole 16a extending from the first main surface to the second main surface. As shown in FIG. 19, the first main surface of base body 16 is provided with an inner shoulder 16b, an outer shoulder 16c, and a liquid reservoir 16d formed between inner and outer shoulders 16b, 16c. Liquid reservoir 16d is configured to receive a liquid 34 (FIG. 31), such as water, with which the working material, such as a ceramic material (e.g., porcelain) in the form of powder, is admixed during the dental technical work. During use, the ceramic mixture rapidly commences to harden or set after preparation due to water loss through evaporation. For this reason, water or other suitable liquid is added to maintain the ceramic mixture in a workable state in order to avoid unnecessary mixings of the ceramic mixture as well as avoid the problems resulting from the trapping of air bubbles in the ceramic mixture, including reduced strength of the resulting dental restorative, as described above. This helps maintain the proper moisture content of the ceramic mixture during use and storage thereof.

Bearing member 22 is a cylinder-shaped bearing provided with a through hole 22a. Bearing member 22 is securely mounted to the first main surface of base body 16 by a suitable fastener 28 (e.g., a screw) that extends into through holes 16a, 22a as shown in FIGS. 21 and 22. As shown in FIGS. 2 and 20, the second main surface of base body 16 is provided with a substantially circular trench or groove 16e configured to receive therein foot element 24, also substantially circular in configuration, so that foot element 24 extends outwardly from groove 16e, as shown in FIGS. 4, 5, 8, 9, 21 and 22, for engaging a surface of structure (e.g., a laboratory bench) during use of dental mixing palette 10. Foot element 24 is securely attached in groove 16e of base body 16 using suitable connecting means, such an adhesive.

Rotary platter 20, also substantially circular in configuration, has opposite first and second main surfaces and is configured to be mounted for undergoing rotation relative to base body 16. The first main surface of rotary platter 20 is substantially flat and has a raised lip 20b. Mixing part 18 is configured to be supported (e.g., sit) on the first main surface of rotary platter 20. The second main surface of rotary platter 20 has a generally cylindrical housing 20a configured to receive bearing member 22 as shown in FIG. 21. By this construction, bearing housing 20a sits on bearing member 22 to allow rotary platter 20, as well as mixing part 18, to rotate on a horizontal plane with bearing member 22 as a pivot. During use, a user can rotate rotary platter 20 and mixing part 18 with a finger in a turntable fashion. The cylindrical interface between bearing housing 20a of rotary platter 20 and bearing member 22 allows rotary platter 20 to be removable by the user for cleaning and for accessing liquid reservoir 16d of base body 16. It is understood that other means for mounting rotary platter 20 for undergoing rotation relative to base body 16 are suitable without departing from the spirit and scope of the invention. Rotational movement of rotary platter 20 relative to base body 16 can be accomplished using a suitable ball bearing mechanism, for example.

Mixing part 18 has opposite first and second main surfaces. The first main surface of mixing part 18 functions as a mixing surface on which the working material is placed during use of dental mixing palette 10. The second main surface of mixing part 18 is configured to sit on the first main surface of rotary platter 20, as described above. The mixing surface of mixing part 18 is preferably a large, substantially flat surface that facilitates mixing of the working material during use of dental mixing palette 10.

In this embodiment, the cover of dental mixing palette 10 is formed of two lids 12, 14 configured to cover all or part of the mixing surface of mixing part 18. As shown in FIGS. 1, 2, 4, and 5, the top edge of outer shoulder 16c of base body 16 serves as a sitting edge for lids 12, 14. Lids 12, 14 are generally semicircular in shape and are removably connected together along the straight edge (diameter) of each semicircle to form a substantially circular shape. Lids 12, 14 are configured to be removably connected together through a hinge connection that permits relative pivotable motion between the lids.

The purpose of lids 12, 14 is to cover and protect the working materials on the mixing surface of mixing part 18. As further described below, when dental mixing palette 10 is in use, the configuration of lids 12, 14 permits the user to selectively remove one of the lids or flip one of the lids over the other to expose only half of the mixing surface of mixing part 18, and alternatively to remove both of the lids to expose the entire mixing surface of mixing part 18.

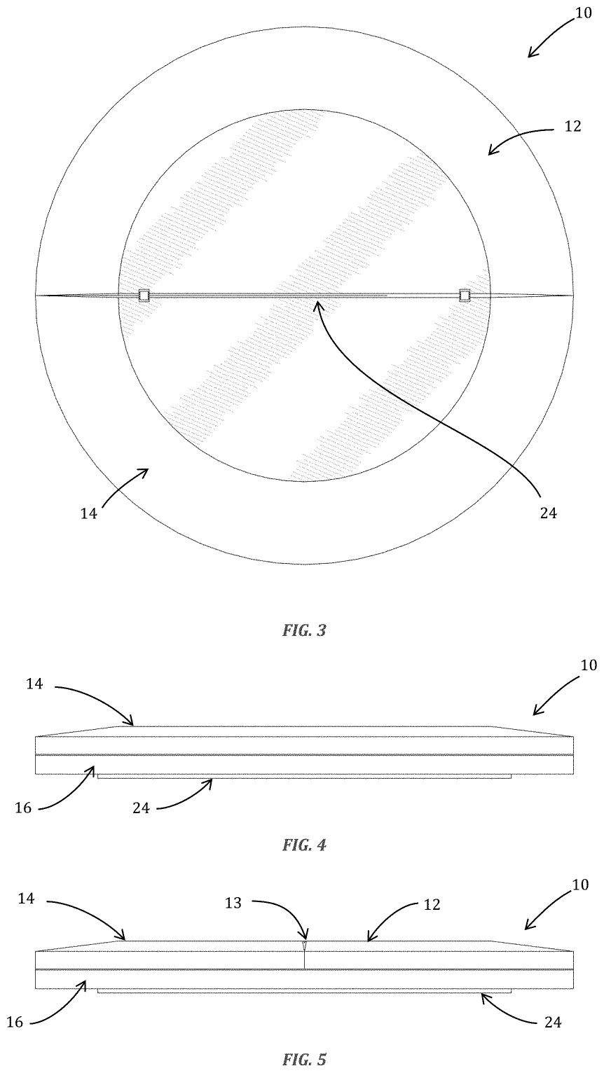

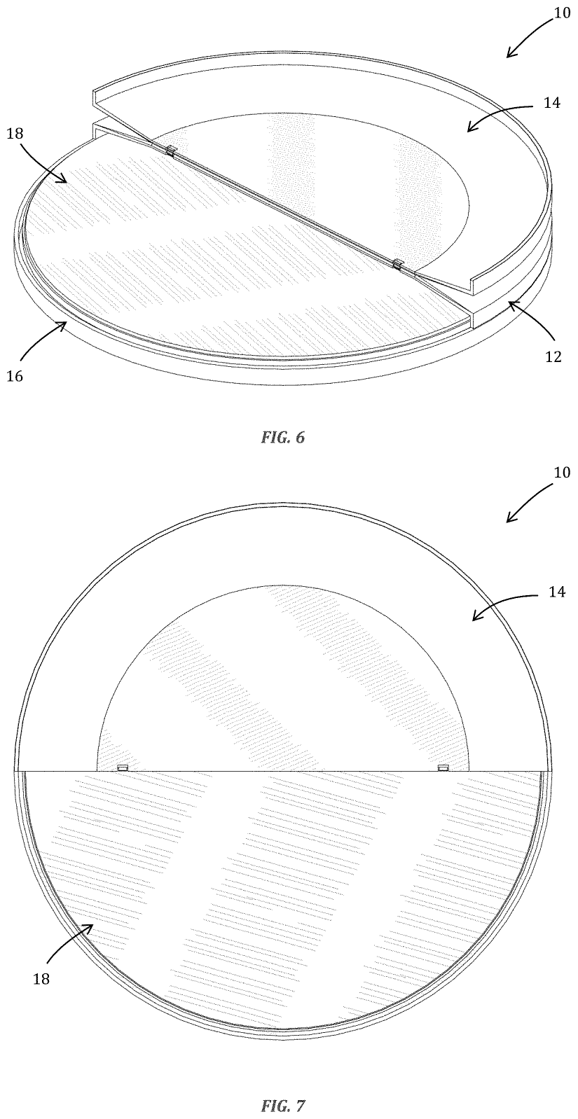

As shown in FIGS. 4 and 5, lids 12, 14 have a slanted profile formed by a generally planar portion partially bounded by a slanted portion of conical shape. When lids 12, 14 are removably connected together to form the substantially circular shape, the combined slanted portions of lids 12, 14 completely surround the corresponding planar portions of lid 12, 14, as shown in FIG. 3. The slanted profile of lids 12, 14 reduces the total volume and improves the overall aesthetics of dental mixing palette 10. Furthermore, an effect of the slanted portions of lids 12, 14 is illustrated in FIGS. 6, 8 and 9 in which the slanted portions of lid 14 are shown at least partially spaced apart from the slanted portions of lid 12 when lid 14 is in the open state and folded over lid 12. This spaced-apart feature further facilitates opening and closing of lids 12, 14 relative one another during use of dental mixing palette 10.

As shown in FIGS. 1, 3, 19 and 20, the hinge connection extends along a hinge line defined by the connected diameters of lids 12, 14. The hinge connection is provided by two hinge clips 30 which hingedly connect lids 12, 14 at two connecting points extending along their diameters and positioned on the generally planar portions of lids 12, 14.

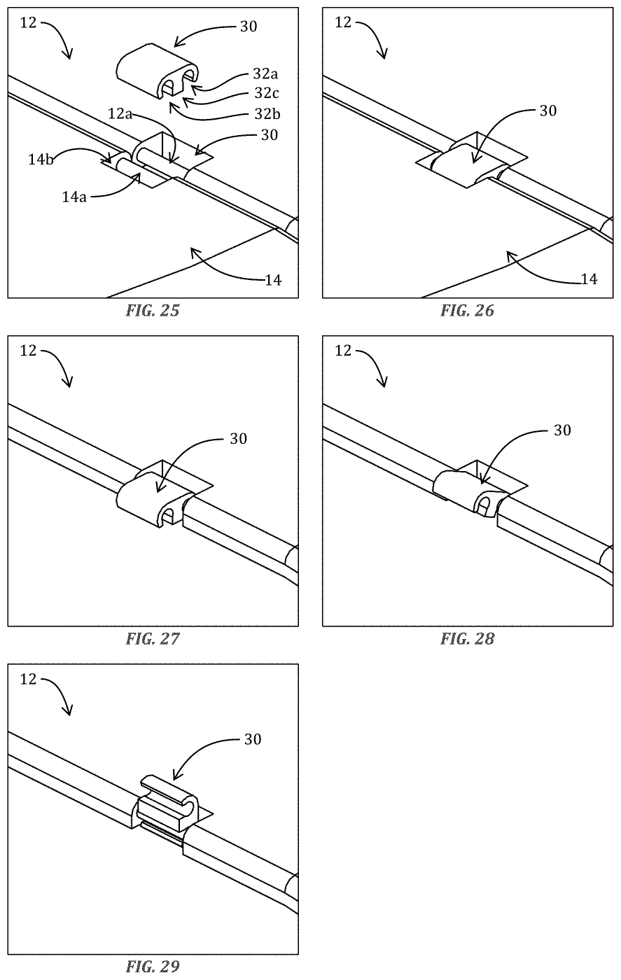

FIGS. 25-29 are close-up views showing details of the removable hinge connection between lids 12, 14. As shown in FIG. 25, each of the two connecting point of lid 12 is formed of a pin 12a disposed within a recess or slot 12b, and each of the two connecting points of lid 14 is formed of a pin 14a disposed within a recess or slot 12b. Each of the two hinge clips 30 has two elongated slots 32a, 32b separated by an elongated ridge 32c. When lids 12, 14 are hingedly connected, for each hinge clip 30 slot 32a is configured to engage pin 12a of lid 12 and slot 32b is configured to engage pin 14a of lid 14, as shown in FIG. 26. FIG. 27 is a view similar to FIG. 26, but with lid 14 removed and hinge clip 30 connected only to lid 12. FIGS. 28 and 29 show hinge clip 30 displaced by various rotation angles relative to hinge clip 30 shown in FIG. 27. It will be appreciated that lids 12, 14 can be readily connected together to provide the hinge connection by quickly engaging slots 32a, 32b of clips 30 with corresponding pins 12a, 14a, respectively, such as by snap fit. Clips 30 can also be readily disconnected from pins 12a, 14a to separate lids 12, 14 from one another. It will also be appreciated that both the connection and disconnection of lids 12, 14 can be accomplished by a user without the need of any complex tool, or accomplished by hand without any tool.

In FIGS. 1-5, lids 12, 14 are shown in a closed state with the top edge of outer shoulder 16c of base body 16 serving as a sitting edge for lids 12, 14. In this closed state, lids 12, 14 cover and protect the working materials on the mixing surface of mixing part 18 when dental mixing palette 10 is not in use. FIGS. 6-18 show various configurations of lids 12, 14 during use of dental mixing palette 10. FIG. 6 is a top perspective view of dental mixing palette 10 showing lid 14 in an open state and folded about the hinge line over lid 12 so as to expose only half of the mixing surface of mixing part 18. FIGS. 7-9 are top, front and side views, respectively, of dental mixing palette 10 shown in FIG. 6. While in FIGS. 6-9 lid 14 is shown in an open state folded over lid 12, it is understood that lid 12 can similarly be placed in an open state and folded over lid 14 so as to expose only the other half of the mixing surface of mixing part 18.

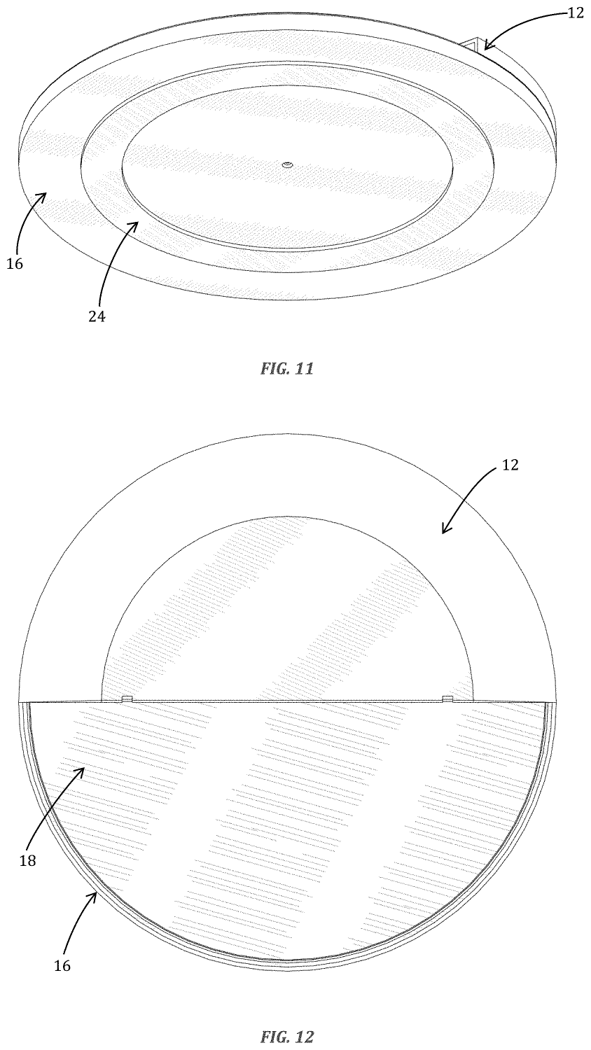

FIG. 10 is a top perspective view of dental mixing palette 10 showing lid 14 disconnected from lid 12 and removed from dental mixing palette 10 to expose only half of the mixing surface of mixing part 18. FIGS. 11-14 are bottom, top, front and side views, respectively, of dental mixing palette 10 shown in FIG. 10. Lids 12 and 14 can be readily disconnected from one another by removing hinge clips 30 as described above. This can be done by hand or by using a simple prying tool as will be appreciated by one skilled in the art. It is understood that lid 12, instead of lid 14, can be removed from dental mixing palette 10 to expose only the other half of the mixing surface of mixing part 18.

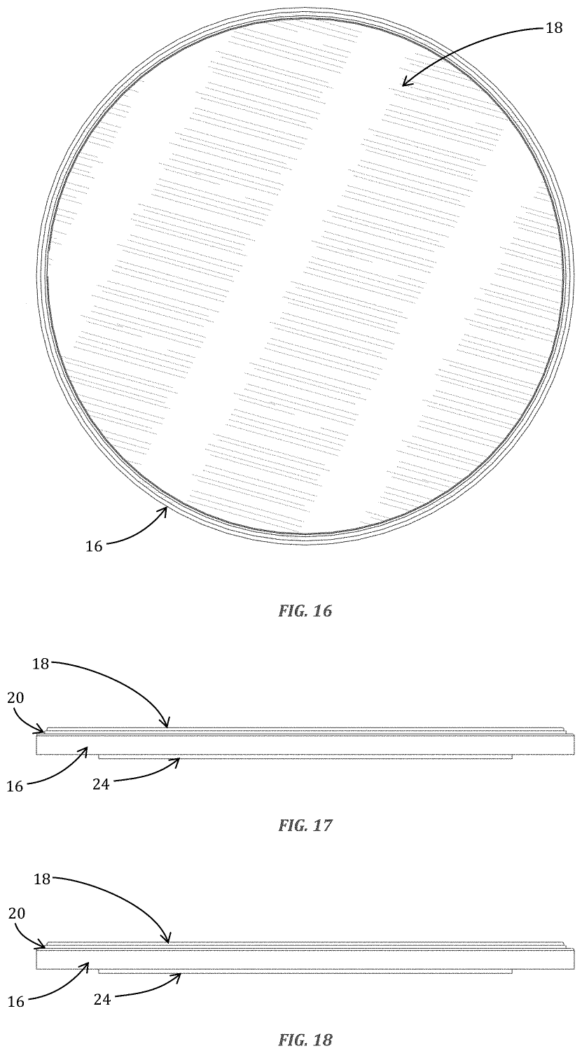

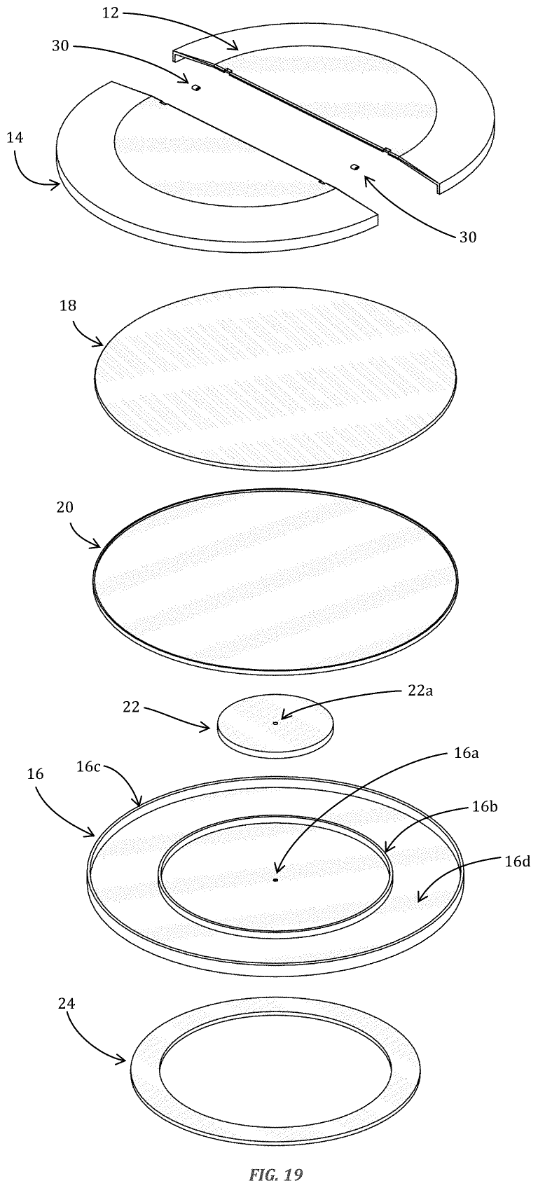

FIG. 15 is a top perspective view of dental mixing palette 10 showing both lids 12, 14 removed from dental mixing palette 10 to expose the entire mixing surface of mixing part 18. FIGS. 16-18 are top, front and side views, respectively, of dental mixing palette 10 shown in FIG. 15.

It will be appreciated that a feature of the dental mixing palette according to the present disclosure is the provision of a cover formed of at least two lids, such as lids 12, 14 as described above. Each lid can be independently displaced relative to the other lid or completely removed from dental mixing palette to selectively expose one or more portions of the mixing surface of mixing part 18. Thus, while in the present embodiment the cover is formed of two lids 12, 14 removably connected together through a hinge connection as described above, it is understood that, without departing from the spirit and scope of the invention, the cover may be formed of more than two lids removably connected together through one or more hinge connections or any equivalent connection that will permit each lid to be selectively placed in an open state or removed from dental mixing palette 10 to selectively cover and/or expose one or more portions of the mixing surface of mixing part 18.

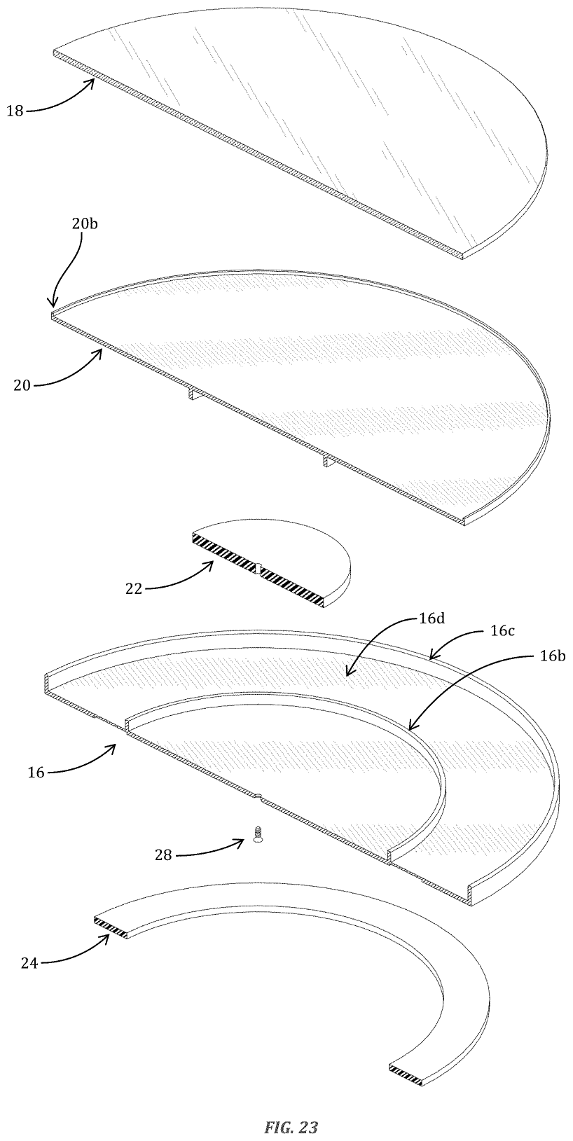

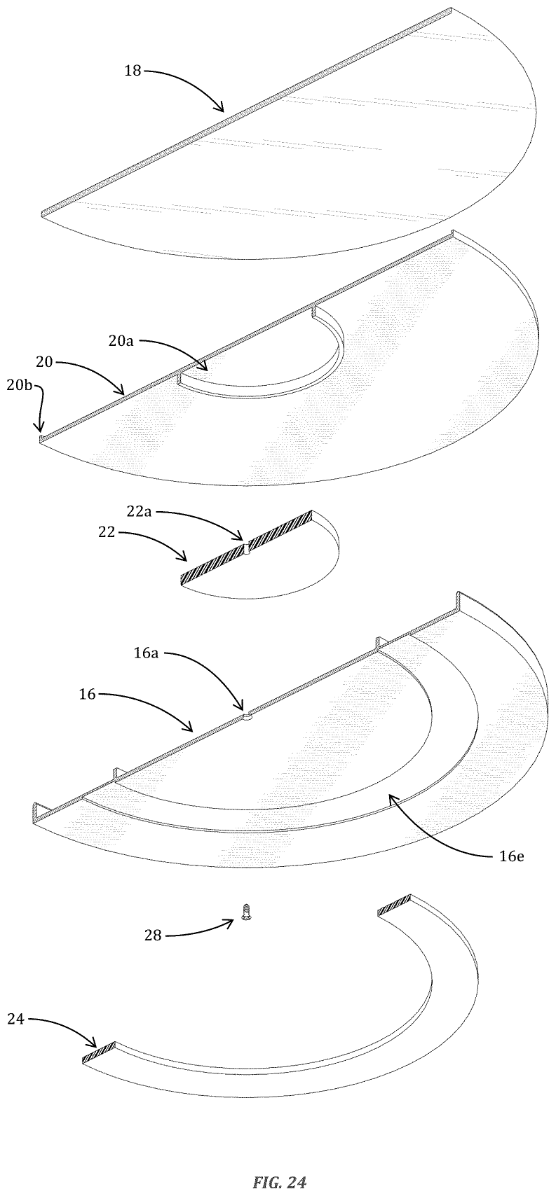

FIG. 23 is a cross-sectional exploded view taken along line 23-23 in FIG. 15, and FIG. 24 is a cross-sectional exploded view taken along line 24-24 in FIG. 15. FIGS. 23 and 24 further illustrate the structural and positional arrangements of the various components of dental mixing palette 10, including base body 16, mixing part 18, rotary platter 20, bearing member 22, and foot element 24.

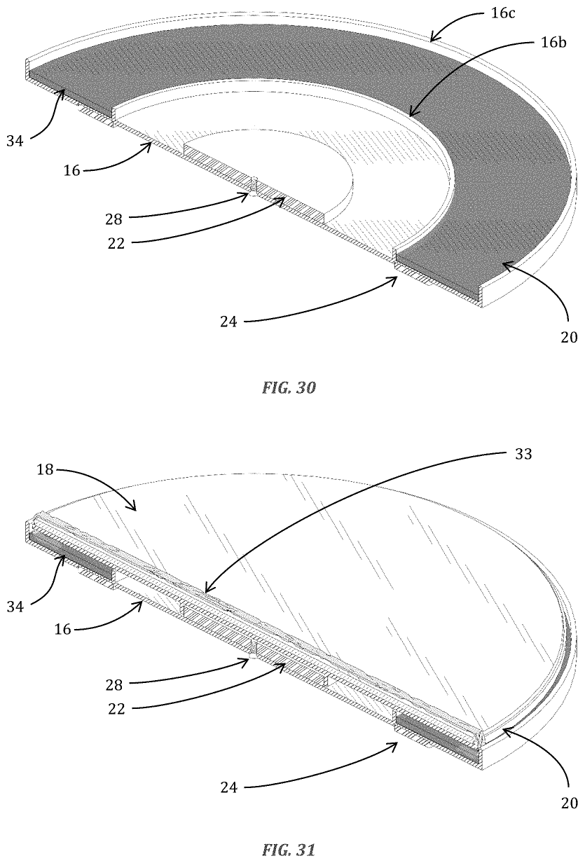

FIG. 30 is a top perspective cross-sectional view of base body 16 similar to FIG. 23 and with bearing member 22 securely mounted to the first main surface of base body 16 using fastener 28. FIG. 30 further illustrates how liquid reservoir 16d formed between inner shoulder 16b and outer shoulder 16c of base body 16 is configured to receive a liquid 34, such as water. During use of dental mixing palette 10 to prepare a dental restorative, the working material, such as a ceramic mixture in powder form, is admixed with liquid 34 to maintain the ceramic mixture in a workable state in order to avoid unnecessary mixings of the ceramic mixture as well as avoid the problems resulting from the trapping of air bubbles in the ceramic mixture, including reduced strength of the resulting dental restorative, as described above. This helps maintain the proper moisture content of the ceramic mixture during use and storage thereof.

FIG. 31 is view similar to FIG. 30 with rotary platter 20 and mixing part 18 further positioned in place relative to base body 16 and bearing member 22. FIG. 31 further illustrates how the first main surface (mixing surface) of mixing part 18 and liquid reservoir 16d are configured to receive/support strips of fabric (wick) 33 for transferring liquid 34 from liquid reservoir 16d to the mixing surface of mixing part 18. Liquid 34 transfers from liquid reservoir 16d to the mixing surface of mixing part 18 via capillary action of fabric strips 33 in a manner well known in the art. The liquid 34 that is transferred to the mixing surface of mixing part 18 is used to maintain the proper moisture of the working material during use and storage thereof as described above.

By the foregoing structural arrangement, it will be appreciated that the dental mixing palette according to the present disclosure has components which are easily separable for cleaning and periodic replacement and is simple and inexpensive to fabricate.

Various materials may be used to fabricate the components of the dental mixing palette according to the embodiment of the present disclosure. For example, base body 16 is made of aluminum or a carbon fiber reinforced plastic. Foot element 24 is made of a suitable rubber material for generating sufficient friction between the second main surface of base body 16 and the work surface on which dental mixing palette is disposed (e.g., a laboratory bench) so that base body 16, and thus the entire dental mixing palette 10, does not displace relative to the work surface during use. Bearing member 22 is made of a suitable nylon material, such as a polyamide commercially available under the tradename ERTALON®, which features good sliding properties and resistance to chemicals. Rotary platter 20 is made of aluminum, such as black anodized aluminum. Mixing part 18 is made of glass having various finishes, such as black opaque, gray or white. Lids 12, 14 are made of aluminum, a carbon fiber reinforced plastic, or a transparent acrylic material such as PMMA (Polymethyl methacrylate), e.g., black tinted PMMA. Hinge clips 30 are made of a suitable plastic material, aluminum or PMMA, preferably painted to match the color selected for lids 12, 14.

The various parts of dental mixing palette 10 which are made of plastic can be fabricated using known injection molding techniques. Furthermore, a benefit of selecting a nylon cylinder as bearing member 22 is that the user can easily lift the rotary platter 20 to clean the parts of dental mixing palette 10 and to fill liquid reservoir 16d of base body 16 with liquid 34. The nylon cylinder also allows easy rotation of rotary platter 20 but can hold the desired position of rotary platter 20, and thus mixing part 18 mounted thereon, during use of dental mixing palette 10.

Below are examples of various specific material combinations for the components of the dental mixing palette according to the present disclosure:

### Material Combination 1

Lids 12, 14: aluminum
Mixing part 18: glass
Rotary platter 20: aluminum
Bearing member 22: nylon
Base body 16: aluminum
Foot element 24: rubber
Hinge clips 30: plastic

### Material Combination 2

Lids 12, 14: PMMA
Mixing part 18: glass
Rotary platter 20: aluminum
Bearing member 22: nylon
Base body 16: aluminum
Foot element 24: rubber
Hinge clips 30: PMMA

### Material Combination 3

Lids 12, 14: carbon fiber reinforced plastic
Mixing part 18: glass
Rotary platter 20: aluminum
Bearing member 22: nylon
Base body 16: carbon fiber reinforced plastic
Foot element 24: rubber
Hinge clips 30: plastic

### Material Combination 4

Lids 12, 14: black tinted PMMA
Mixing part 18: glass
Rotary platter 20: aluminum (black anodized)
Bearing member 22: nylon
Base body 16: carbon fiber reinforced plastic
Foot element 24: rubber
Hinge clips 30: black tinted PMMA

### Material Combination 5

Lids 12, 14: ABS (Acrylonitrile butadiene styrene) plastic
Mixing part 18: glass
Rotary platter 20: ABS plastic (black anodized)
Bearing member 22: nylon
Base body 16: ABS plastic
Foot element 24: rubber
Hinge clips 30: ABS plastic

The overall dimensions of dental mixing palette according to the present disclosure are selected to accommodate the desired application for dental mixing palette. In one exemplary embodiment according to the present disclosure, dental mixing palette has an overall diameter of about 260 mm (10.23 inches), a total height with lids 12, 14 of about 2.55 mm (1 inch), a total height without lids 12, 14 of about 1.5 mm (0.6 inch), and a mixing surface diameter of about 250 mm (9.85 inches).

In the embodiment described herein with reference to FIGS. 1-31, dental mixing palette 10 has a generally circular configuration. It will be appreciated that, without departing from the spirit and scope of the present disclosure, other configurations for dental mixing palette 10 (an corresponding parts) are suitable so long as rotary platter 20 and mixing part 18 are capable of being mounted for undergoing rotational movement relative to base body 16 to facilitate access to the working material on the mixing surface of mixing part 18 during use of dental mixing palette 10.

As described above, dental mixing palette 10 is particularly suitable by dental technicians (user) for ceramic teeth modeling and ceramic fixed restorations. An example of such particular use of dental mixing palette 10 is described below.

After placing dental mixing palette 10 on a structural surface (e.g., a laboratory bench), the user mixes different shades of ceramic porcelain powder or paste (working material) with water or special liquids (e.g., demineralized water) on the mixing surface of mixing part 18. The user then picks up the desired amounts (e.g., a batch) of the mixed materials from the mixing surface and builds-up the tooth volume. During the build-up procedure, the user is able to control the liquid (e.g., water) content (humidity) of the ceramic material. This is accomplished by disconnecting mixing part 18 and rotary platter 20 and filling liquid reservoir 16d with a liquid 34 as shown in FIG. 30, and then reconnecting mixing part 18 and rotary platter 20. The user can then cause liquid 34 to be transferred to the mixing surface of mixing part 18 by laying fabric strips 33 (wick) on the mixing surface and bringing fabric strips 33 in contact with liquid 34 in liquid reservoir 16d, as shown in FIG. 31. The liquid 34 transfers from liquid reservoir 16d to the mixing surface of mixing part 18 via capillary action of fabric strips 33 as is well known in the art. The liquid 34 that is transferred to the mixing surface of mixing part 18 is effective to maintain the proper moisture of the working material during use and storage thereof.

The user can lay the prepared ceramic porcelain on the mixing surface of mixing part 18 as the user sees fit and rotate mixing part 18 (i.e., via rotary platter 20) in a turntable fashion to bring the desired batch of prepared ceramic porcelain in front of the user for easy access. It will be appreciated that by the structural arrangement of dental mixing palette 10 according to the present disclosure, only rotation of mixing part 18 is needed (i.e., there is no need to rotate lids 12, 14) in order to bring the desired working material in front of the user for easier access and workability.

The user can provide access to (i.e., expose) the entire mixing surface of mixing part 18 by removing both lids 12, 14, as shown in FIGS. 15-18. Alternatively, the user can selectively cover only half of the mixing surface of mixing part 18 to protect the batch of ceramic porcelain in that area from dust and dirt to minimize water evaporation. For example, this can be accomplished either by placing (e.g., flipping) lid 14 in the open state and in overlying relation to lid 12, as shown in FIGS. 6-9, or by completely removing lid 14 and keeping lid 12 in place as shown in FIGS. 10-14.

During periods in which the user does not need to work with the ceramic porcelain, the entire mixing surface of mixing part 18 may remain covered by lids 12, 14, as shown in FIGS. 1-5, in order to protect all of the ceramic porcelain which is on the mixing surface from dust and dirt and to avoid excess water evaporation. Furthermore, if the user wants to mix porcelain for different teeth using different batches of the mix, the user can keep the one batch away from him/her, under the closed lid, protected from dust and excess moisture loss, and have the batch which is being used right away conveniently closer to the user.

As described herein, the present disclosure provides a dental mixing palette for mixing and storing ceramic materials, such as dental porcelain, used for dental technical work, such as ceramic fixed restorations. The dental mixing palette of the present disclosure is capable of maintaining the proper moisture content of the materials both during use and storage, and has a mixing surface configured to be easily rotated in a turntable fashion to facilitate access to working material on the mixing surface during use of the dental mixing palette. Furthermore, the dental mixing palette of the present disclosure has components which are easily separable for cleaning and periodic replacement, and is simple and inexpensive to fabricate.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but are to be accorded the widest scope consistent with the principles and novel features disclosed herein.

1. A dental mixing palette for ceramic materials such as dental porcelain, comprising:
a base body;
a bearing member mounted on the base body;
a rotary platter mounted on the bearing member for undergoing rotational movement relative to the base body;
a mixing part disposed on the rotary platter, the mixing part having a mixing surface for supporting the ceramic material; and
a cover configured to selectively cover the entire mixing surface of the mixing part and to selectively expose all or portions the mixing surface.

2. The dental mixing palette of claim 1, wherein each of the base body, bearing member, rotary platter, mixing part and cover is substantially circular in shape.

3. The dental mixing palette of claim 1, wherein the cover comprises two lids removably connected together through a hinge connection that permits relative pivotable motion between the lids.

4. The dental mixing palette of claim 3, wherein the lids, the base body and the rotary platter are made of aluminum, the mixing part is made of glass, and the bearing member is made of a nylon material.

5. The dental mixing palette of claim 3, wherein the lids are made of a transparent acrylic material, the base body and the rotary platter are made of aluminum, the mixing part is made of glass, and the bearing member is made of a nylon material.

6. The dental mixing palette of claim 3, wherein the lids and the base body are made of carbon fiber reinforced plastic, the rotary platter is made of aluminum, the mixing part is made of glass, and the bearing member is made of a nylon material.

7. The dental mixing palette of claim 3, wherein the lids are made of a transparent acrylic material, the base body is made of carbon fiber reinforced plastic, the rotary platter is made of aluminum, the mixing part is made of glass, and the bearing member is made of a nylon material.

8. The dental mixing palette of claim 3, wherein the dental mixing palette has an overall diameter of about 10.23 inches, a total height with the lids of about 1 inch, a total height without the lids of about 0.6 inch, and a mixing surface diameter of about 9.85 inches.

9. The dental mixing palette of claim 3, wherein each of the lids is generally semicircular in shape and are removably connected along diameters of the two semicircular lids; and wherein the hinge connection extends along a hinge line defined by the connected diameters of the two lids.

10. The dental mixing palette of claim 9, wherein the hinge connection comprises two hinge clips configured to hingedly connect the two lids at two connecting points extending along the diameters thereof.

11. The dental mixing palette of claim 10, wherein each of the two connecting points is formed of a pin disposed within a recess of one of the lids and another pin disposed within another recess of the other lid; and wherein each of the hinge clips has two slots separated by a ridge, and for each hinge clip the slots are configured to removably engage respective pins forming the connecting points of the lids.

12. The dental mixing palette of claim 1, further comprising a foot element mounted on a surface of the base body opposite to a surface of the base body on which the bearing member and rotary platter are disposed.

13. The dental mixing palette of claim 12, wherein the foot element is made of a rubber material and is configured to engage a surface of a support structure during use of the dental mixing palette.

14. The dental mixing palette of claim 1, wherein the bearing member is removably mounted on the base body by a fastener.

15. The dental mixing palette of claim 1, wherein the base body has a liquid reservoir for containing a liquid used for mixing with a ceramic material applied on the mixing surface of the mixing part.

16. The dental mixing palette of claim 15, wherein the liquid in the liquid reservoir is transported to the mixing surface of the mixing part by capillary action of fabric strips placed on the mixing surface and in contact with the liquid in the liquid reservoir.

17. The dental mixing palette of claim 15, wherein the base body has a main surface provided with an inner shoulder forming a space for receiving the bearing element and an outer shoulder forming with the inner shoulder the liquid reservoir.

18. A dental mixing palette comprising: a base body; a bearing member mounted on the base body; a rotary platter mounted on the bearing member for undergoing rotational movement relative to the base body; a mixing part disposed on the rotary platter; and a cover configured to selectively, removably covering the mixing part.

19. The dental mixing palette of claim 18, wherein the base body has a liquid reservoir for containing a liquid.

20. The dental mixing palette of claim 19, wherein the liquid in the liquid reservoir is transported to the mixing surface of the mixing part by capillary action of fabric strips placed on the mixing part and in contact with the liquid in the liquid reservoir.
